(19) United States
(12) Patent Application Publication
(10) Pub. No.: US 2006/0065740 A1
(43) Pub. Date: Mar. 30, 2006

(54) Low cost user input module

(76) Inventors: Nicholas P. Lyons, Sunnyvale, CA (US); Philippe Debaty, Mountain View, CA (US); Patrick M. Goddi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/950,102

(22) Filed: Sep. 24, 2004

(51) Int. Cl. G06K 19/06

(52) U.S. Cl. 235/492

(57) ABSTRACT

A user input module that enables user input without the relatively high costs associated with dedicated user input mechanisms or the relatively high costs associated with handheld devices. A user input module for a device according to the present teachings includes a set of RFID tags for storing a user input and a switching mechanism for activating the RFID tags such that the RFID tags when activated transmit the user input. Devices may use RFID readers to obtain the transmitted user input and then act on the user input as appropriate.

### BACKGROUND

A wide variety of venues may include an arrangement of devices that provide services to users. For example, a conference room may include audio/visual devices that may be employed by individuals in the conference room. In another example, an information center at an institution or amusement park, etc. may include a variety of devices for providing information to visitors.

It may be desirable to provide individuals at a venue with the capability of accessing the functions of the devices contained within the venue. For example, it may be desirable to provide individuals who enter a conference room with the capability of using the audio/visual devices in the conference room. Similarly, it may be desirable to provide visitors to an information center of an institution or amusement park with the capability of using the devices in the information center.

A set of devices contained in a venue may be equipped with dedicated user input mechanisms. For example, a conference room may include user input devices, e.g. keyboard, keypad, etc. for controlling conference room devices. Unfortunately, the cost of equipping a venue with dedicated user input mechanisms may be relatively high. In addition, dedicated user input mechanisms may be subject to theft or vandalism and may lack a flexibility that enables frequent changes to a user interface.

Individuals may employ handheld devices to access the devices contained in a venue. Examples of handheld devices include PDAs and cell phones. A handheld device may enable an individual to establish a wireless communication link with the devices in a venue and enter commands to the devices. Unfortunately, such a method may exclude access to devices by individuals who are not in possession of a relatively expensive handheld device.

### SUMMARY OF THE INVENTION

A user input module is disclosed that enables user input without the relatively high costs associated with dedicated user input mechanisms or the relatively high costs associated with handheld devices. A user input module for a device according to the present teachings includes a set of RFID tags for storing a user input and a switching mechanism for activating the RFID tags such that the RFID tags when activated transmit the user input. Devices may use RFID readers to obtain the transmitted user input and then act on the user input as appropriate.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a user input module that accesses a device according to the present teachings;

FIG. 2 shows a database that holds a set of information associated with a user input stored in a user input module;

FIG. 3 illustrates one embodiment of an RFID tag that includes an antenna and a microcontroller having a memory;

FIG. 4 shows one method for implementing a switching mechanism in an RFID tag;

FIG. 5 shows another user input module according to the present teachings;

FIG. 6 shows one example method for employing a user input module to interact with a device;

FIG. 7 shows a venue that may be controlled with a user input module according to the present techniques;

FIG. 8 shows another venue that may be controlled with a user input module according to the present techniques.

### DETAILED DESCRIPTION

FIG. 1 shows a user input module 20 that accesses a device 10 according to the present teachings. The user input module 20 includes a button 22 and an RFID tag 24 that corresponds to the button 22. The RFID tag 24 stores a user input 410 that may be acted upon by the device 10. For example, the user input 410 may be a code, set of data, etc., that may be acted upon by the device 10.

The user input module 20 includes a switching mechanism for activating the RFID tag 24. The RFID tag 24 when activated transmits the user input 410 associated with the button 22. In one embodiment, a holder of the user input module 20 activates the RFID tag 24 by pressing the button 22. The switching mechanism in the RFID tag 24 may be a switch between a microcontroller and an RF antenna in the RFID tag 24.

An RFID reader 14 establishes an RF communication link 30 to the RFID tag 24 when the RFID tag 24 is activated. The RFID reader 14 obtains the user input 410 from the RFID tag 24 via the RF communication link 30. The device 10 obtains the user input 410 from the RFID reader 14 and in response may perform one or more functions.

The device 10 may be any type of device that is capable of user interaction. Examples include visual display devices, e.g. televisions, plasma displays, large auditorium displays, specialized event displays, computer monitors, etc. as well as audio systems, e.g. home audio systems, public address systems, etc., and audio/visual systems, information systems, vending machines, environmental control devices, etc.

The RFID reader 14 may be separate from the device 10 as shown or may be integrated into the device 10.

The user input 410 may specify an input function for a user interface associated with the device 10. For example, the device 10 may perform a function corresponding to the button 22 in response to the user input 410. The functions of the device 10 that may be instigated via the user input module 20 may depend on the particular nature of the device 10. For example, if the device 10 is a media rendering device then the user input module 20 may be used to select media objects to be rendered on the device 10. In another example, if the device 10 is an environmental controller, e.g. temperature or lighting control, then the user input module 20 may be use to switch on/off lights, adjust temperature, etc.

The device 10 may include a visual display that provides visual feedback to a holder of the user input module 20. For example, the device 10 may include a display device that displays a graphical user interface to a user. Alternatively, audio feedback or other types of human perceptible feedback may be employed.

The user input 410 may identify a holder of the user input module 20. For example, the user input 410 may include an account number associated with a holder of the user input module 20.

The user input 410 may identify a media file that may be rendered by the device 10. For example, the user input 410 may identify a video and/or audio file to be rendered on the device 10.

The user input 410 may include a set of profile attributes that pertain to a holder of the user input module 20. The profile attributes may be used by the device 10 to adapt its functions to the holder of the user input module 20. For example, the profile attributes may specify a spoken language, e.g. English, French, Italian, Spanish, etc., and the device 10 in response may generate a user interface display using the specified spoken language. In another example, the profile attributes may specify a particular subject of interest, e.g. types of shopping, amusement rides, events, etc., and the device 10 in response may generate a user interface display that is adapted to that particular subject.

The user input 410 may include scripts or programs that may be executed by the device 10. For example, a script or program may cause the device 10 to perform a sequence of functions.

The user input 410 may include a serial number associated with the RFID tag 24.

The user input 410 may be flexibly remapped per device and the mapping may depend on the context of the device.

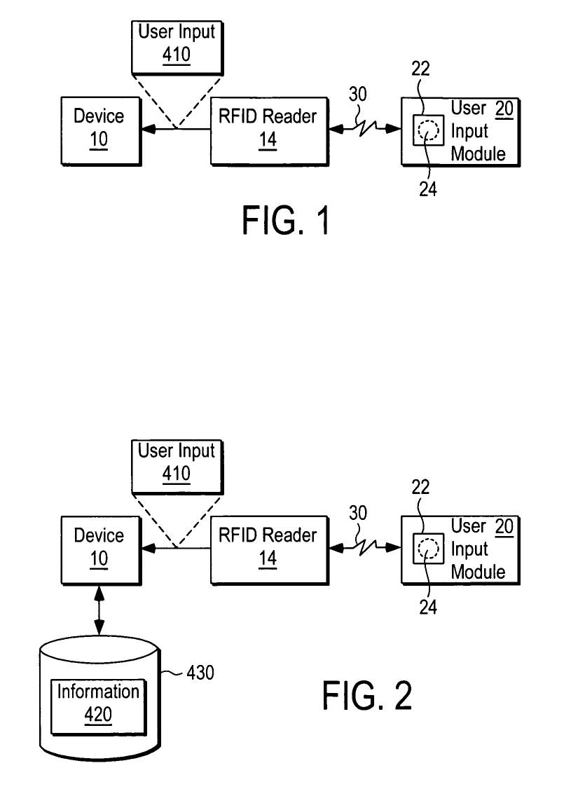

FIG. 2 shows a database 430 that holds a set of information 420 associated with the user input 410 stored in the user input module 20. In one embodiment, the user input 410 includes a pointer that enables the device 10 to retrieve the information 420 from the database 430. The information 420 may specify an asset, e.g. a media file or other type of file, associated with the user input 410. The information 420 may specify an instruction or action to be taken by the device 10 in response to the user input 410. The information 420 may include scripts or programs that may be executed by the device 10. The database 430 may include security controls that prevent exposure of the information 420 to unauthorized parties.

The device 10 obtains the user input 410 from the user input module 20 when the button 22 is activated and in response uses the user input 410 to perform a lookup to the database 430. The device 10 reads the information 420 from the database 430 and then takes the appropriate action.

For example, if the information 420 includes a media file then the device 10 renders the media file. If the information 420 provides a pointer to a media file, e.g. a URL of a media file, then the device 10 obtains the media file using the URL, e.g. by using Internet protocols to obtain the media file from a web server via a network connection (not shown).

If the information 420 includes a program then the device 10 executes the program. If the information 420 includes a script then the device 10 executes the script. If the information 420 specifies a sequence of functions for the device 10 then the device 10 performs the specified sequence of functions.

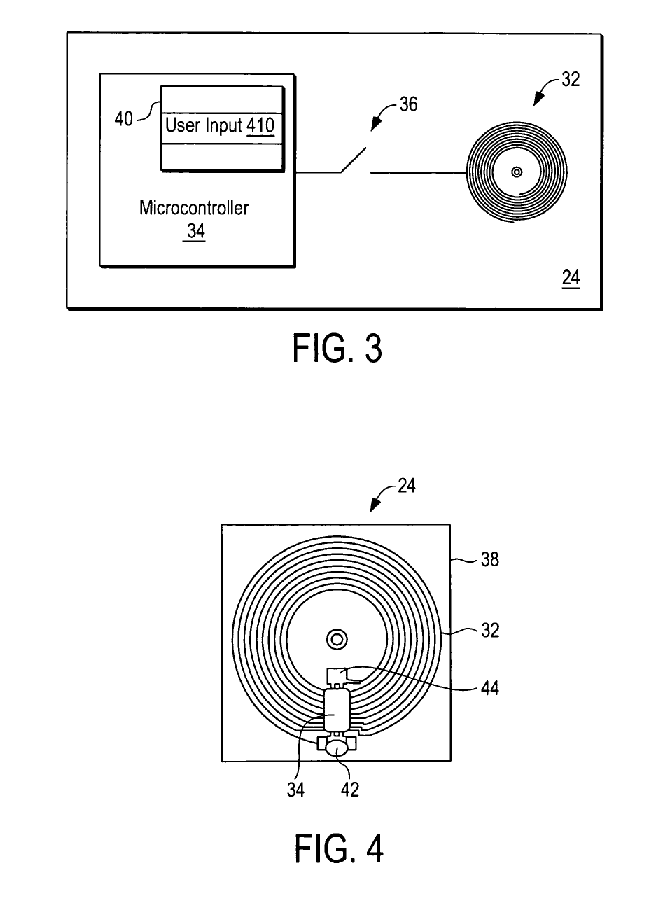

FIG. 3 illustrates one embodiment of the RFID tag 24. The RFID tag 24 includes an antenna 32 and a microcontroller 34 having a memory 40. The RFID tag 24 also includes a switch 36. The switch 36 closes when the button 22 is pressed. The switch 36 when opened disables the RFID tag 24 from activating in the presence of RF energy. The switch 36 when closed enables the RFID tag 24 to activate in the presence of RF energy. The switch 36 is normally open until the button 22 is pressed.

The switch 36 when closed causes the microcontroller 34 to receive electrical power in response to RF energy received via the antenna 32. The RF energy received via the antenna 32 is generated by the RFID reader 14. The microcontroller 34 establishes the communication link 30 with the RFID reader 14 when powered.

The memory 40 is a persistent memory that holds the user input 410 associated with the button 22. The microcontroller 34 reads the user input 410 from the memory 40 and transfers it to the RFID reader 14 via the antenna 32 for the RF communication link 30.

FIG. 4 shows one method for implementing a switching mechanism in the RFID tag 24. The antenna 32 is mounted on a substrate 38. The microcontroller 34 has a hinged contact 42 to the antenna 32 and a contact 44 to the antenna 32. The contact 44 is open until the button 22 that overlays the RFID tag 24 is pressed. Pressure on the button 22 causes the contact 44 to engage the antenna 32 and complete the circuit. The RFID tag 24 may be an off-the-shelf RFID tag with the hinged contact 42 remaining soldered and the contact 44 unsoldered.

A variety of alternative switching mechanisms may be employed to open/close the signal from the antenna 32. For example, a momentary contact switch, e.g. a rubber dome contact switch, may be used to complete the circuit on one of the leads of the antenna 32 between the antenna 32 and the solder pad. This enables both contacts of the microcontroller 34 to be soldered, thereby increasing the strength of attachment of the microcontroller 34. The switching mechanism implemented may be one suited to volume manufacturing of user input modules.

The button 22 may be any material that may be adhered to the top surface of the RFID tag 24. The material for the button 22 may be a material that holds a depiction, e.g. text/graphics, etc., of a function of the button 22 that is associated with the device 10. Example materials for the button 22 include paper and plastic materials.

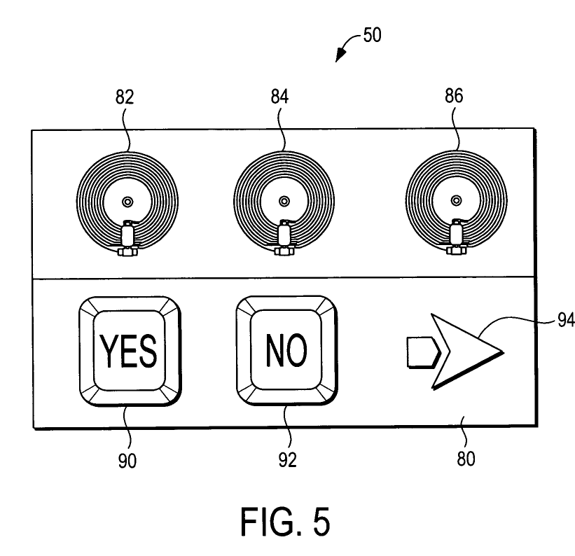

FIG. 5 shows a user input module 50 according to the present teachings. The user input module 50 includes a set of RFID tags 82-86 mounted on a card 80. The user input module 50 includes a set of buttons 90-94. The buttons 90-94 are shown separate from the RFID tags 82-86 for illustration. In operation, the button 90 is mounted on top of the RFID tag 82, the button 92 is mounted on top of the RFID tag 84, and the button 94 is mounted on top of the RFID tag 86.

In this example, the button 90 depicts a “Yes” input, the button 92 depicts a “No” input, and the button 94 depicts a right arrow input. The memory in the microcontroller in the RFID tag 82 is programmed with a user input code associated with the “Yes” input for button 90. Similarly, the memory in the microcontroller in the RFID tag 84 is programmed with a user input code associated with the “No” input of the button 92 and the memory in the microcontroller in the RFID tag 86 is programmed with a user input code associated with the right arrow input of the button 94.

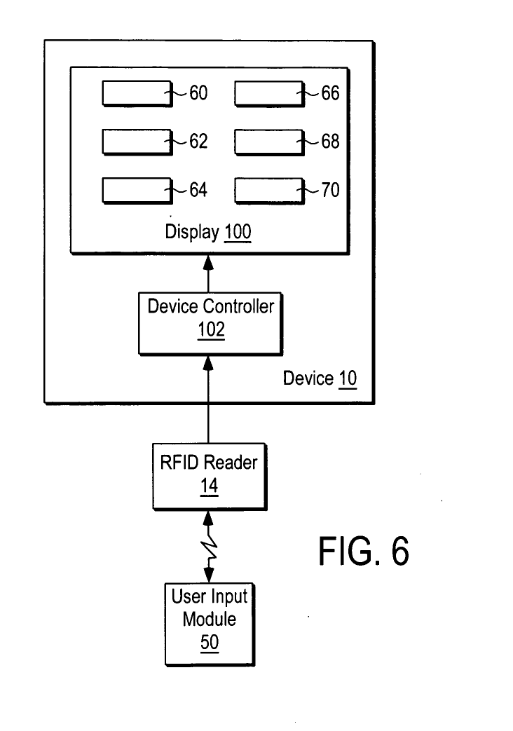

FIG. 6 shows one example method for employing the user input module 50 to interact with the device 10. In this example, the device 10 includes a display 100 and a device controller 102. The device controller 102 generates a set of graphical objects 60-70 on the display 100.

Each graphical object 60-70 is associated with a function of the device 10. For example, if the device 10 is a media playback device then each graphical object 60-70 may depict a title that may be played on the device 10. In another example, if the device 10 is an information device then each graphical object 60-70 may depict an information category that may be serviced by the device 10.

A holder of the user input module 50 interacts with the device 10 by positioning the user input module 50 near the RFID reader 14 and pressing the buttons 90-94 while viewing the display 100. For example, when the holder of the user input module 50 presses the button 90 the device controller 102 obtains the code for the “Yes” input via the RFID reader 14. Similarly, when the holder of the user input module 50 presses the button 92 and then the button 94 the device controller 102 obtains the codes for the “No” input and right arrow input, respectively, via the RFID reader 14.

The device controller 102 performs one or more functions associated with the device 10 in response to the codes received from the user input module 50. For example, the right arrow button 94 may be used to move to a next graphical object 60-70. The device controller 102 may initially highlight the graphical object 60 and the de-highlight the graphical object 60 and highlight the graphical object 62 when the holder of the user input module 50 presses the right arrow button 94. Each successive press of the right arrow button 94 may be used to move the next graphical object. The button 90 may be used to enter a “Yes” input for the currently highlighted graphical object and the button 92 may be used to enter a “No” input for the currently highlighted graphical object.

The device controller 102 may be embodied as a computer system that communicates with the RFID reader 14 via a serial port. Alternatively, an RFID reader may be integrated into the device controller 102.

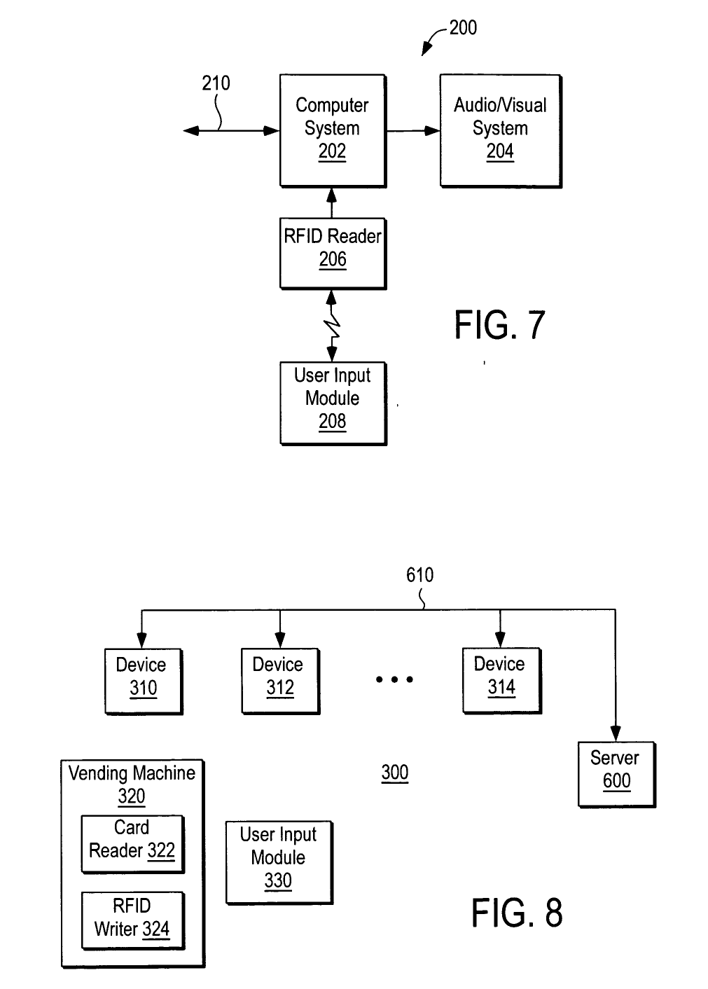

FIG. 7 shows a venue 200 that may be controlled by a user input module 208 according to the present techniques. The venue 200 includes a computer system 202, an audio/visual system 204, and an RFID reader 206. For example, the audio/visual system 204 may include a display, e.g. a projector, plasma, etc., as well as audio amplifier and loudspeakers.

The RFID reader 206 reads a user input from the user input module 208 when it is positioned near the RFID reader 206 and activated. The RFID reader 206 provides the obtained user input to the computer system 202. The computer system 202 then obtains a URL that corresponds to the user input obtained from the user input module 208. For example, the computer system 202 may maintain an internal table that maps a set of possible user inputs contained in the user input module 208 to corresponding URLs.

The computer system 202 uses the obtained URL to obtain an object and then renders the object on the audio/visual system 204 according to a MIME-type associated with the URL. For example, if the obtained URL points to a web page then the computer system 208 obtains the web page and renders it on the audio/visual system 204. If the obtained URL points to an mp3 file then the computer system 202 obtains the mp3 file and renders it on the audio/visual system 204. If the obtained URL points to a video file then the computer system 202 obtains the video file and renders it on the audio/visual system 204.

The computer system 202 may obtain objects specified by a URL from its own internal storage or may obtain objects using web protocols via a network communication link 210.

FIG. 8 shows a venue 300 that may be controlled with a user input module 330 according to the present techniques. The venue 300 includes a set of devices 310-314 that may be controlled with the user input module 330. Each device 310-314 may include an integrated RFID reader. Alternatively, the devices 310-314 may share an RFID reader.

The venue 300 includes a vending machine 320 that dispenses the user input module 330. The vending machine 320 in this embodiment includes a card reader 322 and an RFID writer 324.

The card reader 322 reads account information from a card provided by a holder of the user input module 330. For example, a holder may insert a credit card into the card reader 322. The card reader 322 reads an account number from the credit card and the RFID writer 324 programs the account number into the input module 330. For example, the RFID writer 324 may program the account number into a memory of an RFID tag of the user input module 330.

The user input module 330 once dispensed by the vending machine 320 may be employed to control any one or more of the devices 310-314. The devices 310-314 obtain the account number of the holder of the user input module 330 from the user input module 330 and log charges to the holders account. For example, a holder of the user input module 330 may access the functions of the device 310 by pressing buttons on the user input module 330 near the RFID reader in the device 310. The RFID reader of the device 310 reads the user inputs from the user input module 330 including the account number for the holder. The holder of the user input module 330 may roam among the devices 310-314 and be charged only for the functions of the devices 310-314 that are accessed.

The vending machine 320 may enable the user input module 330 only for the devices 310-314 that are paid for at the time of vending. For example, a holder of the user input module 330 may use a front panel user interface on the vending machine 320 to select a subset of the devices 310-314. The holder may then enter payment for the selected devices, e.g. by providing cash or a credit card, into the vending machine 320. The vending machine 320 then programs user input codes into the user input module 330 only for the devices and/or functions for which payment is made. For example, the microcontroller memory in the RFID tag for each button on the user input module 330 may store a validation code for each of the devices 310-314 and the vending machine 320 programs only the validation codes for which payment is made.

The vending machine 320 may write account information associated with a holder of the user input module 330 into a server 600 that is accessible by the devices 310-314 via a communication path 610. The vending machine 320 may write a pointer to the account information contained on the server 600 into the user input module 330. The server 600 may include security controls for protecting the account information. The holder of the user input module 330 may then roam among the devices 310-314 and access the functions of the devices 310-314 using the pointer programmed into the user input module 330 and the devices 310-314 obtain the account information from the server 600.

A user input module according to the present teachings may implement a variety of switching arrangements. For example, a user input module may include a set of RFID tags that are switched using a multi-pole switching mechanism such that each active switch position activates a corresponding RFID tag.

In addition, a user input module may include a chord switch arrangement. A chord switch may include a set of RFID tags each having a corresponding switching mechanism. A user may activate any combination of the RFID tags in the chord and the combination may provide a chord code that may be acted upon by a device. For example, a device may include an RFID reader that is capable of reading multiple RFID tags that transmit at the same time. An encoding of functions using a chord code may enable space saving on a user input module and reduce the cost of manufacturing a user input module.

The foregoing detailed description of the present invention is provided for the purposes of illustration and is not intended to be exhaustive or to limit the invention to the precise embodiment disclosed. Accordingly, the scope of the present invention is defined by the appended claims.

1. A user input module, comprising:
RFID tag for storing a user input for controlling a device;
switching mechanism for activating the RFID tag, the RFID tag when activated transmitting the user input such that an RFID reader receives the user input and provides the user input to the device.

2. The user input module of claim 1, wherein the switching mechanism comprises a switch between a microcontroller and an RF antenna in the RFID tag.

3. The user input module of claim 2, wherein the switching mechanism further comprises a button positioned to activate the switch.

4. The user input module of claim 1, further comprising a set of additional RFID tags such that switching mechanism switches among activating the RFID tag and the additional RFID tags to provide the user input.

5. The user input module of claim 1, further comprising a set of additional RFID tags and corresponding switching mechanisms such that the RFID tag and the additional RFID tags transmit a chord code for the user input.

6. The user input module of claim 1, wherein the user input specifies a function associated with the device.

7. The user input module of claim 1, wherein the user input specifies a function for a user interface of the device.

8. The user input module of claim 1, wherein the user input identifies a holder of the user input module.

9. The user input module of claim 1, wherein the user input includes an account number associated with a holder of the user input module.

10. The user input module of claim 1, wherein the user input maps to a media file.

11. The user input module of claim 1, wherein the user input includes a set of profile attributes that pertain to a holder of the user input module.

12. The user input module of claim 1, wherein the user input includes a program.

13. The user input module of claim 1, wherein the user input includes a pointer to a set of information contained in a database.

14. The user input module of claim 13, wherein the information specifies a function associated with the device.

15. The user input module of claim 13, wherein the information identifies a holder of the user input module.

16. The user input module of claim 13, wherein the information includes an account number associated with a holder of the user input module.

17. The user input module of claim 13, wherein the information maps to a media file.

18. The user input module of claim 13, wherein the information includes a set of profile attributes that pertain to a holder of the user input module.

19. The user input module of claim 13, wherein the information includes a program.

20. A system, comprising:
device that performs a function in response to a user input;
user input module including a set of RFID tags for storing the user input and further including a switching mechanism for activating the RFID tags such that the RFID tags when activated transmit the user input to an RFID reader which provides the user input to the device.

21. The system of claim 20, wherein the user input specifies a function associated with the device.

22. The system of claim 20, wherein the user input specifies a function for a user interface of the device.

23. The system of claim 20, wherein the user input identifies a holder of the user input module.

24. The system of claim 20, wherein the user input includes an account number associated with a holder of the user input module.

25. The system of claim 20, wherein the user input maps to a media file.

26. The system of claim 20, wherein the user input includes a set of profile attributes that pertain to a holder of the user input module.

27. The system of claim 20, wherein the user input includes a program.

28. The system of claim 20, further comprising a database such that the user input includes a pointer to a set of information contained in the database.

29. The system of claim 28, wherein the information specifies a function associated with the device.

30. The system of claim 28, wherein the information identifies a holder of the user input module.

31. The system of claim 28, wherein the information includes an account number associated with a holder of the user input module.

32. The system of claim 28, wherein the information maps to a media file.

33. The system of claim 28, wherein the information includes a set of profile attributes that pertain to a holder of the user input module.

34. The system of claim 28, wherein the information includes a program for the device.
